(19) United States
(12) Patent Application Publication
(10) Pub. No.: US 2026/0311247 A1
(43) Pub. Date: Oct. 8, 2026

(54) Characterizing Attribute Level Impact on Model Outputs

(71) Applicant: Consumerinfo.com, Inc., Costa Mesa, CA (US)

(72) Inventors: David Burdelski, Winchester, MA (US); Veronica Herrera, Winchester, CA (US); Mindy James, Riverview, FL (US)

(21) Appl. No.: 19/169,951

(22) Filed: Apr. 3, 2025

(51) Int. Cl. G06Q 40/03; G06N 20/20; G06Q 10/10

(52) U.S. Cl. CPC G06Q 40/03; G06N 20/20; G06Q 10/10

(57) ABSTRACT

Values are respectively extracted or derived for each of a plurality of attributes from each of a first file and a second file. Using the extracted or derived values form the second file, a model from among an ensemble of models is selected to score the second file. The values extracted or derived from the first file and the second file are respectively input into the selected model to receive a first score characterizing the first file and a second score characterizing the second file. Thereafter, differences in values for corresponding attributes from the first file and the second file are determined so that, for each attribute having a change in value, a score value impact can be determined. This score value impact can be based on the difference in value for the attribute and the corresponding weight used by the selected model for the attribute.

### TECHNICAL FIELD

The subject matter described herein relates to techniques for enhancing the explainability of diverse computer-implemented models which, in turn, are used to characterize complex input data having varying attribute values. In particular, the current subject matter characterizes how an output of a model is impacted by changes in attribute values used to generate the output.

### BACKGROUND

Model explainability is increasingly being adopted across diverse applications to allow end users to get a better understanding about how models operate and make decisions. Certain regulated industries, in particular the financial industry, require compliance with a certain level of model explainability and transparency.

### SUMMARY

In a first aspect, values are extracted or derived from a first file for each of a plurality of attributes. In addition, values are extracted or derived from a second file for each of the plurality of attributes. Using the extracted or derived values from the second file, a model from among an ensemble of models is selected to score the second file. The selected model has one or more weights corresponding to each attribute. The values extracted or derived from the first file are input into the selected model to receive a first score characterizing the first file. In addition, the values extracted or derived from the second file are input into the selected model to receive a second score characterizing the second file. Thereafter, differences in values for corresponding attributes from the first file and the second file are determined so that, for each attribute having a change in value, a score value impact can be determined. This score value impact can be based on the difference in value for the attribute and the corresponding weight used by the selected model for the attribute. Data characterizing the determined score value impact for each attribute can be provided to a consuming application or process.

The first file can be generated at a first point in time prior to a second point in time at which the second file is generated.

In some variations, the first and second files are credit reports and the first and second scores characterize creditworthiness.

The selected model can take varying forms such as a statistical model (e.g., regression model, etc.) or a machine learning model (e.g., a neural network, etc.).

In an interrelated aspect, values are extracted or derived for each of a plurality of attributes from a first file. These extracted or derived values from the first file are input into a model to receive a first score characterizing the first file. Further, values are extracted or derived for each of the plurality of attributes from a second file. These extracted or derived values from the second file are input into the model to receive a second score characterizing the first file. Differences in values for corresponding attributes from the first file and the second file are determined. An iterative operation commences in which, for each attribute having a change in value, the value of the corresponding attribute from the first file along with values from the second file which correspond to different attributes are input into the model to determine a score value impact for the attribute. Data characterizing the determined score value impact for each attribute can be provided to a consuming application or process.

The first file can be generated at a first point in time prior to a second point in time at which the second file is generated.

The model can include an ensemble of models (e.g., segments, etc.). One of the models forming part of the ensemble of models can be selected based on values of attributes in either of the first file or the second file. Stated differently, the particular model can be selected if the values, for example, meet certain criteria (e.g., one or more attribute values fall within a desired range, etc.). The selected model from the ensemble of models can be the model that generates the first score, the second score, and determines the score value impact for the attributes having a change in value.

In some variations, the model includes a plurality of sub-models and one of the sub-models is selected based on values of attributes in either of the first file or the second file. The selected sub-model can be used to generate the first score, the second score, and to determine the score value impact for the attributes having a change in value.

The first and second files can be credit reports and the first and second scores can characterize creditworthiness.

The model can include at least one statistical model such as, for example, a regression model. In other variations, the model can include at least one machine learning model such as, for example, a neural network.

In another interrelated aspect, values for each of a plurality of attributes are extracted from each of a first file and a second file. Based on the extracted or derive values, a segment from among an ensemble of segments is selected to score the second file. The selected segment has weights corresponding to each attribute. The values extracted or derived from the first file are input into the selected segment to receive a first score characterizing creditworthiness of an entity at a first point in time. In addition, the values extracted or derived from the second file are input into the selected segment to receive a second score characterizing creditworthiness of the entity at a second, later point in time. Difference in values for corresponding attributes from the first file and the second file are determined. For each attribute having a change in value, a score value impact is determined based on the difference in value for the attribute and the corresponding weight used by the selected segment for the attribute. Data characterizing the determined score value impact for each attribute can be provided to a consuming application or process which can, for example, cause information explaining the determined score value impact for at least one of the attributes to be displayed in a graphical user interface.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides enhanced model transparency for complex model architectures serving large populations of users. Furthermore, the current subject matter is technically advantageous in that provides model transparency while not exposing the model algorithm used to generate the corresponding output.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating an example computing environment;

FIG. 2 is a diagram illustrating a workflow for characterizing attribute level impact on model outputs; and

FIG. 3 is a diagram illustrating aspects of a computing device for implementing the current subject matter.

### DETAILED DESCRIPTION

The current subject matter is directed to advanced techniques for characterizing how an output of a model is impacted by changes in inputted attribute values used to generate the output. The current subject matter is applicable to a wide variety of model architectures as applied to different industries in which consumer-facing model explainability is needed or otherwise beneficial.

Creditworthiness is one illustrative, but non-limiting application, for which the current subject matter can be applied. As an example, lenders typically pull a consumer's credit score on a periodic basis to see if they continue to meet the terms of their agreement. Changes to a consumer's credit score could result in changes to the terms of their account—such as credit limits and available features. The current subject matter is advantageous in that it can provide a consumer greater insight into the reason the consumers credit score changed so that it can be better positioned to manage and improve their creditworthiness.

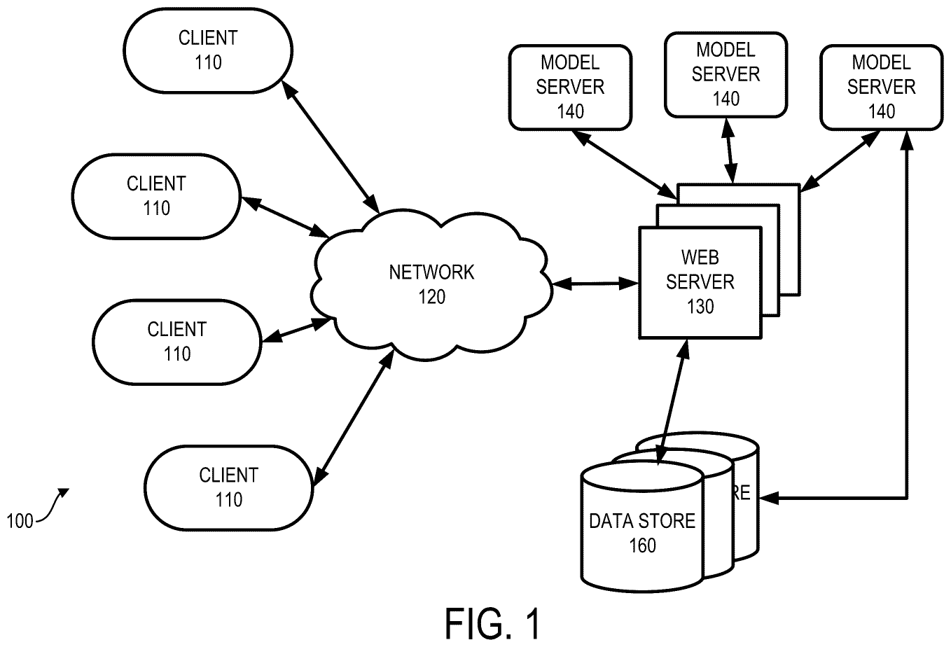

FIG. 1 is a system diagram 100 which illustrates an example computing environment for executing aspects of the current subject matter. A plurality of client devices 110 can communicate, over a network 120, with one or more web servers 130. These web servers 130 can communicate with one or more model servers 140 which respectively execute one or models. The models being executed can take varying forms including statistical models as well as machine learning models. In some cases, there can be a plurality of different models (i.e., an ensemble of models, etc.) in which each model corresponds to a different segment. In some variations, there can be a plurality of models corresponding to each segment.

One or more data stores 160 can store files from which attributes are extracted and/or derived and input into the one or more models being executed by the model servers 140. The data store(s) 160 can also store information regarding historically calculated scores and, in some cases, the files used to generate such scores. The data stores 160 can be cloud-based storage and/or dedicated databases. The model servers 140 can interface with the data store 160 directly or indirectly (for example, by way of the web server(s) 130). As will be described in further detail below, a requesting user, by way of one of the client devices 110, can request that one of the model servers 140 score or otherwise classify a file. The file to be scored can form part of the request from the client 110 or it can be stored within one or more of the data stores 160. In some cases, the client device 110 can request a most recently calculated score (i.e., a score that was previously generated by one or more of the model servers 140) be analyzed as opposed to requesting one of the models to generate a new score based on the file.

Turning again to the creditworthiness example, current industry and regulatory standards leverage creditworthiness score factors to educate a consumer on how their credit score was calculated from their credit report. The reasons why these factors have changed can be difficult for the average consumer to understand. Financial educators have worked to create more informative features, such as score ingredients and trackers to help consumers better understand their current credit score and plot credit score/report changes over time.

The current subject matter can be implemented as a credit score model algorithm to identify or otherwise characterize the specific point value associated to individual credit report changes. As will be described in further detail below, attribute level changes to the credit report are compared to determined what causes the credit score to change. Information characterizing the reasons for the change can be conveyed to an end-user (e.g., consumer, lender, etc.).

With the creditworthiness example, the current subject matter can be used to compare information from a consumer's current credit report with information generated their previous one. The current subject matter analyze changes in attributes which, in turn, caused the credit score to change at an attribute level. If a significant change (which can be user-defined/configurable) is detected, a breakdown of the changes to the credit report can be conveyed to a user in a graphical user interface along with a credit score point value to each such change.

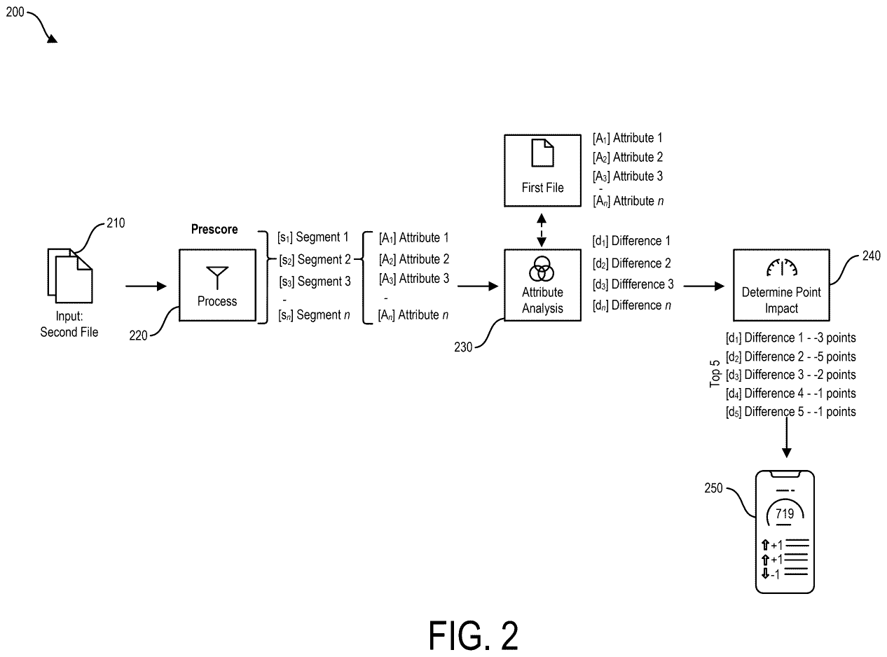

FIG. 2 is a process flow diagram 200 illustrating a workflow for explaining changes in model outputs (e.g., segment outputs, etc.) which can, as an example, be executed by one or more of the model servers 140. The changes can be in reference to a first file and a second file which are generated at different points in time. The first file can represent an earlier snapshot of the subject matter being scored and the second file can represent a subsequent snapshot of the subject matter being scored. Initially, at 210, the second file is received over a computing network, accessed locally and/or obtained from a remote data store 160. A file, in this context and unless otherwise specified, refers to one or more documents (or other forms of collected information/data) from which values for attributes will be extracted or otherwise derived from. With the creditworthiness example, a file can be a credit report which, in turn, can comprise financial transaction information for a consumer derived from one or more credit bureaus or other sources.

In some cases, the model servers 140 execute an ensemble of models and/or sub-models (e.g., regression models, neural networks, etc.). The individual models and/or sub-models can be referred to herein as segments. Each segment can be fine-tuned to use the most predictive set of attributes to generate the applicable score (e.g., consumer's credit score, etc.). In some variations, given that the segments are fine-tuned to optimize their predictive value, the set of attributes and/or attribute weightings used by each segment can vary.

After attributes are extracted from the second file, a determination can be made, at 220, as to which segment should score or otherwise classify the file. In other words, based on the values of the extracted or derived attributes, a particular segment will be selected to analyze the second file. The segments can utilize different attributes and/or different weighting values relative to other segments. In the creditworthiness context, the segment can pertain to various factors such as credit usage. The determination can be made, for example, using a pre-score model which looks at, for example, values for different attributes within the file to see if they fall within specific ranges (which in turn can be specified by a rule set or policy). In some implementations, a single model is utilized obviating the need to determine which segment should score or otherwise classify a file.

In addition, at 230, the second file can be compared relative to the first file to determine difference in attribute values. In other word, differences in values between the second file and the first file can be calculated on an attribute-by-attribute level. In some variations, the differences can be rank ordered by absolute value. This ranking can be used, for example, to prioritize a subsequent analysis regarding score impact (especially if conducted in a sequential or iterative manner).

Thereafter, at 240, using the selected segment, a computer-based score impact analysis executing one or more algorithms can be performed. In a first variation of the score impact analysis, each changed attribute can be isolated while all other attributes of the second file can be held constant. With such a score impact analysis, each changed attribute can be processed individually through the segment to determine the specific point value impact on the score (e.g., the credit score, etc.). In other words, for a particular attribute value, the computer-based score impact analysis can provide for the value of a particular attribute in both of the first file and the second file to be input into the segment along with all other attribute values in the second file to generate second scores (the difference of which can be used to determine or otherwise characterize scoring impact based on the attribute value changes). In other variations, a more computationally expensive multivariate or combinatorial analysis can be employed in which the computer-based score impact analysis concurrently varies two or more attribute value as opposed to isolating all but one of the attribute values (e.g., the combination of a change in attribute 1 with a change in attribute 2 caused the score of the second file to change by x points).

In some variations, the score impact analysis can analyze the weights used by the underlying model in order to determine score value impact. In cases in which there are an ensemble of segments/models, attributes can have varying weights in each of the corresponding segments/models. Changes in attribute values (i.e., delta values) can be multiplied by the corresponding weights for such attribute in the particular segment/model in order to determine score impact relative to the overall model score. These calculations can be used to characterize the attribute value's contribution to the score change which, in turn, can allow for ranking of the various contributions based on score impact level.

Later, at 250, data characterizing the determined impacts (i.e., detailed reasons why the score generated from the second file differed from the score generated from the first file) can be provided to a consuming application or process. Provided, in this context, can include one or more of: transmitting the data to a remote computing device over a network, loading the data into memory, storing the data in physical persistence, or causing the data to be displayed in a graphical user interface of an electronic visual display.

In some cases, the consuming application or process, based on the determined impacts, can wrap the provided data with explanations on how the changes in attribute values impacted the score (for ultimate display in a graphical user interface).

These explanations can be based on various rules, policies, or templates and be consumed by downstream applications or processes. In some cases, the explanations can be template to provide a consistent user experience (thus enhancing overall model explainability). As an example, a graphical user interface can be caused to display “The total number of opened and closed auto loans on your file [increased] from [1] to [2] [lowering] your score by [6] points.”

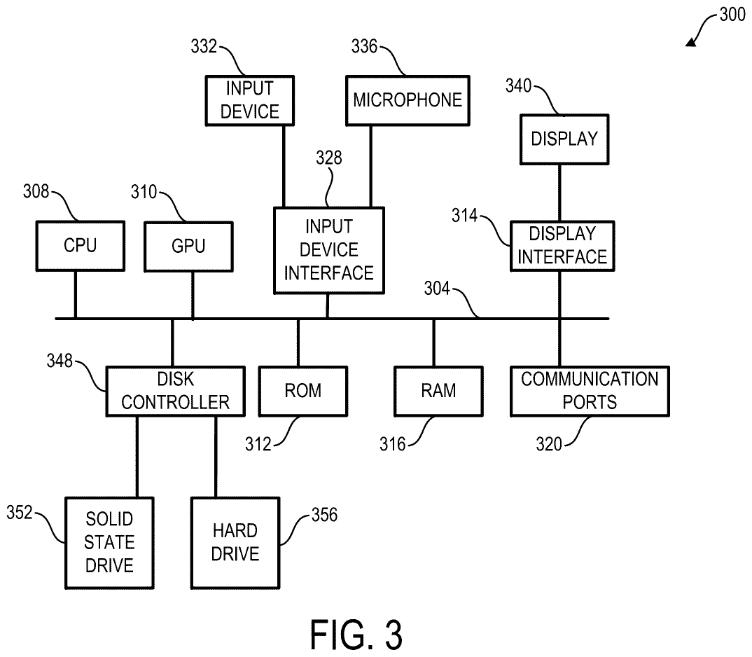

FIG. 3 is a diagram 300 illustrating a sample computing device architecture for implementing various aspects described herein. A bus 304 can serve as the information highway interconnecting the other illustrated components of the hardware. A processing system 308 labeled CPU (central processing unit) (e.g., one or more computer processors/data processors at a given computer or at multiple computers), can perform calculations and logic operations required to execute a program. In addition, a processing system 310 labeled GPU (graphics processing unit) (e.g., one or more computer processors/data processors at a given computer or at multiple computers), can perform calculations and logic operations required to execute a program. A non-transitory processor-readable storage medium, such as read only memory (ROM) 312 and random access memory (RAM) 316, can be in communication with the processing system 308 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 348 can interface with one or more optional disk drives to the system bus 304. These disk drives can be external or internal solid state drives 352 or hard drives 356. system bus 304 can also include at least one communication port 320 to allow for communication with external devices either physically connected to the computing system or available externally through a wired or wireless network. In some cases, the at least one communication port 320 includes or otherwise comprises a network interface.

To provide for interaction with a user, the subject matter described herein can be implemented on a computing device having a display device 340 (e.g., a LED (light emitting diode) or LCD (liquid crystal display) monitor) for displaying information obtained from the bus 304 via a display interface 314 to the user and an input device 332 such as keyboard and/or a pointing device (e.g., a mouse or a trackball) and/or a touchscreen by which the user can provide input to the computer. Other kinds of input devices 332 can be used to provide for interaction with a user as well; for example, feedback provided to the user can be any form of sensory feedback (e.g., visual feedback, auditory feedback by way of a microphone 336, or tactile feedback); and input from the user can be received in any form, including acoustic, speech, or tactile input. The input device 332 and the microphone 336 can be coupled to and convey information via the bus 304 by way of an input device interface 328. Other computing devices, such as dedicated servers, can omit one or more of the display 340 and display interface 314, the input device 332, the microphone 336, and input device interface 328.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C,” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method comprising:
extracting or deriving values for each of a plurality of attributes from a first file;
extracting or deriving values for each of the plurality of attributes from a second file;
selecting, based on the extracted or derived values from the second file, which model forming part of an ensemble of models to score the second file, the selected model having weights corresponding to each attribute;
inputting the values extracted or derived from the first file into the selected model to receive a first score characterizing the first file;
inputting the values extracted or derived from the second file into the selected model to receive a second score characterizing the second file;
determining differences in values for corresponding attributes from the first file and the second file;
determining, for each attribute having a change in value, a score value impact based on the difference in value for the attribute and the corresponding weight used by the selected model for the attribute; and
providing data characterizing the determined score value impact for each attribute to a consuming application or process.

2. The method of claim 1, wherein the first file is generated at a first point in time prior to a second point in time at which the second file is generated.

3. The method of claim 1, wherein the first and second files are credit reports and the first and second scores characterize creditworthiness.

4. The method of claim 1, wherein the model comprises at least one statistical model.

5. The method of claim 4, wherein the statistical model is a regression model.

6. The method of claim 1, wherein the model comprises at least one machine learning model.

7-18. (canceled)

19. A computer-implemented method comprising:
extracting or deriving values for each of a plurality of attributes from a first file;
extracting or deriving values for each of the plurality of attributes from a second file;
selecting, based on the extracted or derived values from the second file, which segment forming part of an ensemble of segments to score the second file, the selected segment having weights corresponding to each attribute;
inputting the values extracted or derived from the first file into the selected segment to receive a first score characterizing creditworthiness of an entity at a first point in time;
inputting the values extracted or derived from the second file into the selected segment to receive a second score characterizing creditworthiness of the entity at a second, later point in time;
determining differences in values for corresponding attributes from the first file and the second file;
determining, for each attribute having a change in value, a score value impact based on the difference in value for the attribute and the corresponding weight used by the selected segment for the attribute; and
providing data characterizing the determined score value impact for each attribute to a consuming application or process.

20. The method of claim 19, wherein the consuming application or process causes information explaining the determined score value impact for at least one of the attributes to be displayed in a graphical user interface.

21. The method of claim 1, wherein the method is performed by one or more model servers that communicate over a network with one or more web servers, and wherein the one or more web servers receive requests from a plurality of client devices to score files stored in one or more data stores.

22. The method of claim 1, wherein the second file is received over a computing network from a remote data store, and wherein extracting or deriving values for each of the plurality of attributes from the second file is performed by one or more data processors executing instructions stored in a non-transitory computer-readable storage medium.

23. The method of claim 1, wherein determining the score value impact comprises executing, by at least one data processor, a computer-based score impact analysis that isolates each changed attribute while holding all other attributes of the second file constant, and processing each changed attribute individually through the selected model to determine a specific point value impact on the second score.

24. The method of claim 1, wherein determining the score value impact comprises executing, by at least one data processor, a multivariate analysis that concurrently varies two or more attribute values to determine a combined score value impact for the two or more attributes.

25. The method of claim 1, wherein providing data characterizing the determined score value impact comprises at least one of: transmitting the data to a remote computing device over a network, loading the data into memory, or storing the data in physical persistence.

26. The method of claim 1, wherein the selected model comprises a neural network executed by one or more model servers, and wherein the weights corresponding to each attribute are learned weights of the neural network.

27. The method of claim 19, wherein the method is performed by one or more model servers that execute the ensemble of segments, and wherein the one or more model servers communicate over a network with one or more web servers that interface with one or more data stores storing the first file and the second file.

28. The method of claim 19, wherein selecting which segment forming part of the ensemble of segments to score the second file comprises executing, by at least one data processor, a pre-score model that evaluates whether values for different attributes within the second file fall within specific ranges specified by a rule set.

29. The method of claim 19, wherein determining the score value impact comprises executing, by at least one data processor, a computer-based score impact analysis that multiplies differences in attribute values by corresponding weights used by the selected segment to characterize each attribute value's contribution to a change between the first score and the second score.

30. The method of claim 19, further comprising ranking, by at least one data processor, the determined score value impacts based on score impact level to prioritize subsequent analysis regarding score impact.

31. The method of claim 19, wherein providing data characterizing the determined score value impact comprises causing the consuming application or process to generate template-based explanations of how changes in attribute values impacted the first score and the second score, and rendering the template-based explanations in the graphical user interface of an electronic visual display.

32. The method of claim 19, wherein the selected segment comprises at least one of a regression model or a neural network executed by one or more model servers, and wherein the weights corresponding to each attribute vary from weights used by other segments in the ensemble of segments.
